(19) United States
(12) Patent Application Publication
(10) Pub. No.: US 2016/0300583 A1
(43) Pub. Date: Oct. 13, 2016

(54) AUDIO SAMPLE RATE CONTROL METHOD APPLIED TO AUDIO FRONT-END AND RELATED NON-TRANSITORY MACHINE READABLE MEDIUM

(71) Applicant: MEDIATEK INC., Hsin-Chu (TW)

(72) Inventors: Pei-Lin Hsu, Hsinchu City (TW); Chi-Peng Chang, New Taipei City (TW); Hsin-Ping Cheng, Hsinchu County (TW)

(73) Assignee: MEDIATEK INC., Hsin-Chu (TW)

(21) Appl. No.: 15/037,328

(22) PCT Filed: Oct. 29, 2015
(86) PCT No.: PCT/CN2015/093188

§ 371 Date: May 18, 2016

Related U.S. Application Data
(60) Provisional application No. 62/069,960, filed on Oct. 29, 2014.

(51) Int. Cl. G10L 21/01; G06F 3/16

(52) U.S. Cl. CPC G10L 21/01; G06F 3/162

(57) ABSTRACT

An audio sample rate control method includes at least the following steps: when an audio source is required to undergo audio playback via an audio front-end (AFE), checking a sample rate control criterion; and performing sample rate control upon the AFE according to a checking result of the sample rate control criterion.

### CROSS REFERENCE TO RELATED APPLICATIONS

This application claims the benefit of U.S. provisional application No. 62/069,960, filed on Nov. 29, 2014 and incorporated herein by reference.

### TECHNICAL FIELD

The disclosed embodiments of the present invention relates to a sample rate control scheme, and more particularly, to an audio sample rate control method applied to an audio front-end and related non-transitory machine readable medium.

### BACKGROUND

Typically, audio playback hardware implemented in an electronic device is configured to have a fixed sample rate for audio playback. For example, the sample rate of the audio playback hardware is not adjustable during an audio playback session. When an audio file to be output via the audio playback hardware has a sample rate different from the fixed sample rate employed by the audio playback hardware, a conventional sample rate conversion operation is enabled to transform the audio file into an audio file with an adjusted sample rate equal to the fixed sample rate employed by the audio playback hardware. However, the sample rate conversion operation is time-consuming, which results in high power consumption. Further, the sample rate conversion operation introduces undesired latency and distortion, which results in audio quality degradation.

Thus, there is a need for an innovative audio playback system that is capable of effectively reducing the use of the sample rate conversion operation to thereby achieve lower power consumption and/or better audio quality.

### SUMMARY

In accordance with exemplary embodiments of the present invention, an audio sample rate control method applied to an audio front-end and related non-transitory machine readable medium are proposed.

According to a first aspect of the present invention, an exemplary audio sample rate control method is disclosed. The exemplary audio sample rate control method includes: when an audio source is required to undergo audio playback via an audio front-end (AFE), checking a sample rate control criterion; and performing sample rate control upon the AFE according to a checking result of the sample rate control criterion.

According to a second aspect of the present invention, an exemplary non-transitory machine readable medium having a program code stored therein is disclosed. When executed by a processor, the program code instructs the processor to perform following steps: when an audio source is required to undergo audio playback via an audio front-end (AFE), checking a sample rate control criterion; and performing sample rate control upon the AFE according to a checking result of the sample rate control criterion.

### BRIEF DESCRIPTION OF THE DRAWINGS

FIG. 1 is a diagram illustrating an electronic device according to an embodiment of the present invention.

FIG. 2 is a diagram illustrating an audio playback system according to an embodiment of the present invention.

FIG. 3 is a flowchart illustrating a first decision flow of an audio sample rate control method according to an embodiment of the present invention.

FIG. 4 is a flowchart illustrating a second decision flow of an audio sample rate control method according to an embodiment of the present invention.

FIG. 5 is a flowchart illustrating a third decision flow of an audio sample rate control method according to an embodiment of the present invention.

FIG. 6 is a flowchart illustrating a fourth decision flow of an audio sample rate control method according to an embodiment of the present invention.

These and other objectives of the present invention will no doubt become obvious to those of ordinary skill in the art after reading the following detailed description of the preferred embodiment that is illustrated in the various figures and drawings.

### DETAILED DESCRIPTION

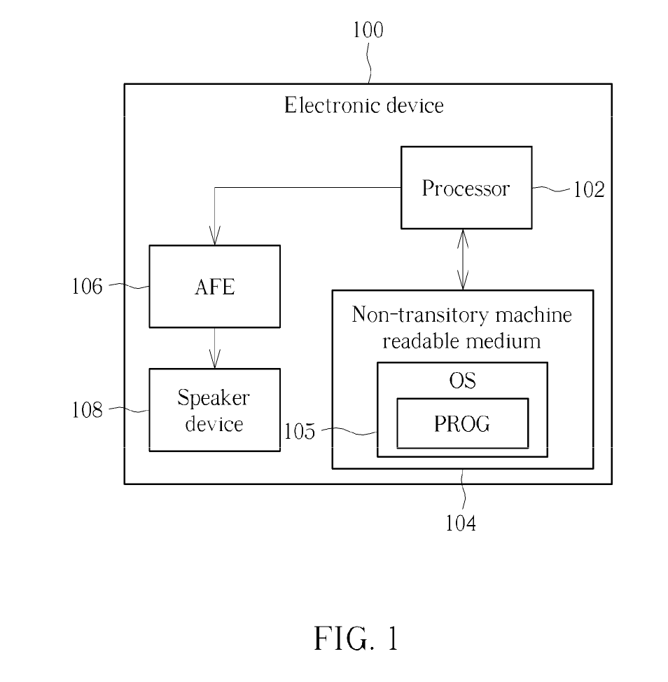

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections. FIG. 1 is a diagram illustrating an electronic device according to an embodiment of the present invention. The electronic device 100 may be a mobile phone, a tablet, a wearable device, a desktop computer, a laptop computer, or any device equipped with audio playback capability. As shown in FIG. 1, the electronic device 100 may include a processor 102, a non-transitory machine readable medium 104, an audio front-end (AFE) 106, and a speaker device 108. In this embodiment, all of the illustrated components, including processor 102, non-transitory machine readable medium 104, AFE 106 and speaker device 108, may be located inside the electronic device 100. Alternatively, one or more of the illustrated components may be located outside the electronic device 100. The AFE 106 may be a hardware component (e.g., integrated circuit (IC)) designed to drive the speaker device 108 for audio playback, where the speaker device 108 may include one or more speaker units. The processor 102 may be a single-core processor or a multi-core processor. The non-transitory machine readable medium 104 may be a volatile storage device (e.g., dynamic random access memory) or a non-volatile storage device (e.g., flash memory or hard disk), and may have a program code PROG stored therein. For example, the program code PROG may be part of a software module (e.g., policy manager) included in an operating system (OS) 105 such as an Android system or a Linux-based system. When loaded and executed by the processor 102, the program code PROG may instruct the processor 102 to perform the proposed audio sample rate control method, including at least the following steps: checking a sample rate control criterion when an audio source may be required to undergo audio playback via the AFE 106, and performing sample rate control upon the AFE 106 according to a checking result of the sample rate control criterion. Further details of the proposed audio sample rate control method are described as below.

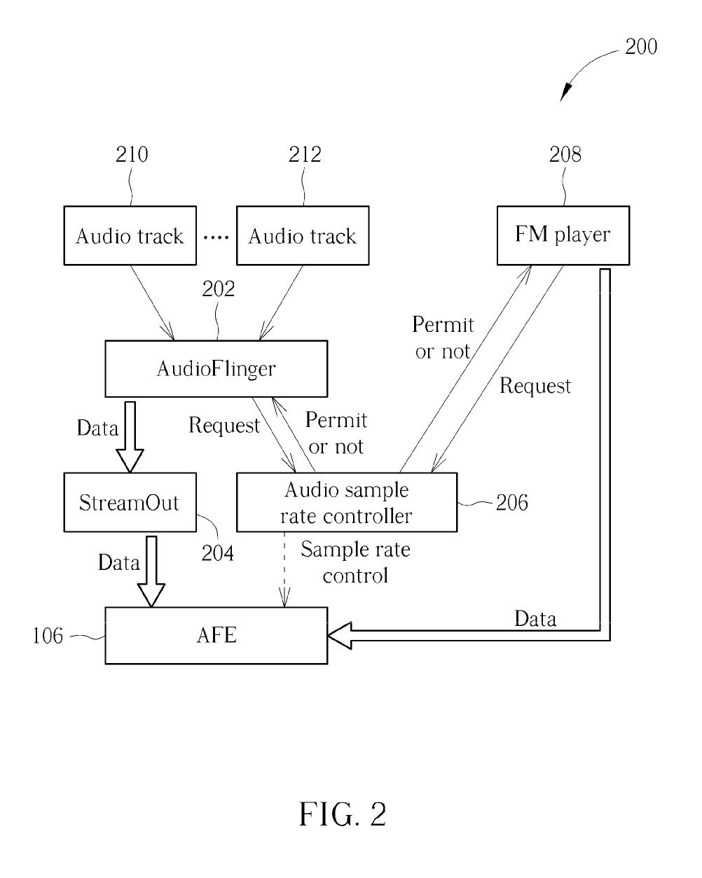

FIG. 2 is a diagram illustrating an audio playback system according to an embodiment of the present invention. The audio playback system 200 may be implemented in the electronic device 100 shown in FIG. 1. By way of example, but not limitation, the audio playback system 200 may be realized by software module(s), hardware component(s) or a combination thereof. In this embodiment, the AFE 106 may be a hardware component, and the AudioFlinger module 202, the StreamOut module 204, the audio sample rate controller 206 and the FM player 208 may be software modules such as software modules of the OS 105. It should be noted that the audio sample rate controller 206 may be implemented using the program code PROG (which may be responsible for performing the proposed audio sample rate control method). The AudioFlinger module 202, the StreamOut module 204 and the FM player 208 may include well-known functions. For example, the AudioFlinger module 202 may be designed to support a plurality of default post-processing functions, including the aforementioned sample rate conversion. The StreamOut module 204 may be an audio hardware interface between the AudioFlinger module 202 and the AFE 106, and may be designed to support a plurality of extra post-processing functions, such as equalization (EQ) and dynamic range compression (DRC). The audio sample rate controller 206 may perform sample rate control regarding one or more audio sources. The audio source(s) may include, but not limited to, audio track(s) (e.g. audio tracks 210 and 212) and FM player (e.g. FM player 208). The FM player 208 may be one audio source used to provide a radio broadcasting input.

It should be noted that the components in FIG. 2 are for illustrative purposes only, and are not meant to be limitations of the present invention. One or more components may be added to or removed from the audio playback system 200. For example, the AudioFlinger module 202 and the StreamOut module 204 may be omitted or may be replaced by other components.

As shown in FIG. 2, the AudioFlinger module 202 may be used to receive audio input(s) from one or more audio sources (e.g., audio tracks 210 and 212) distinct from the FM player 208. The examples of the audio tracks may include, but not limited to, a song to be played by a music player, a notification sound of an instant messaging application, etc. In one exemplary implementation, the AudioFlinger module 202 may support software-based audio mixing and sample rate conversion, while the AFE 106 may support hardware-based audio mixing and sample rate conversion. For example, audio mixing and/or sample rate conversion of an audio input generated from the FM layer 208 may be performed inside the AFE 106 without intervention of the AudioFlinger module 202, and audio mixing and/or sample rate conversion of an audio input generated from any of the audio tracks 210 and 212 may be performed inside the AudioFlinger module 202. However, this is not meant to be a limitation of the present invention.

When the audio track 210 may be required to undergo audio playback via the AFE 106 (e.g., audio track 210 may join audio playback), the AudioFlinger module 202 may generate a sample rate request of a sample rate (e.g., 48 KHz, 44.1 KHz, 192 KHz, etc.) of the audio track 210 to the audio sample rate controller 206, and the audio sample rate controller 206 may decide whether the requested sample rate is permitted or denied, and may further perform sample rate control upon the AFE 106 according to a sample rate control criterion. When the audio track 212 may be required to undergo audio playback via the AFE 106 (e.g., audio track 212 may join audio playback), the AudioFlinger module 202 may generate a sample rate request of a sample rate (e.g., 48 KHz, 44.1 KHz, 192 KHz, etc.) of the audio track 212 to the audio sample rate controller 206, and the audio sample rate controller 206 may decide whether the requested sample rate is permitted or denied, and may further perform sample rate control upon the AFE 106 according to a sample rate control criterion. When the FM player output may be required to undergo audio playback via the AFE 106 (e.g., FM player 208 may join audio playback), the FM player 208 may generate a sample rate request of a sample rate (e.g., 44.1 KHz, 48 KHz, 192 KHz, etc.) of the FM player output to the audio sample rate controller 206, and the audio sample rate controller 206 may decide whether the requested sample rate is permitted or denied, and may further perform sample rate control upon the AFE 106 according to a sample rate control criterion. After the sample rate may be determined by the audio sample rate controller 206 in response to a sample rate request issued from the FM player 208, the FM player output may be fed into the AFE 106 for audio playback.

In one exemplary design, the sample rate control applied to the AFE 106 may be indirectly achieved via AudioFlinger module 202 and StreamOut module 204. That is, the audio sample rate controller 206 may control the AudioFlinger module 202, the AudioFlinger module 202 may control the StreamOut module 204, and the StreamOut module 204 may control the AFE 106. However, this is for illustrative purposes only, and is not meant to be a limitation of the present invention. Alternatively, the audio sample rate controller 206 may apply sample rate control to the AFE 106 directly. This also falls within the scope of the present invention.

Since the present invention focuses on the audio sample rate controller 206 (particularly, the proposed audio sample rate control method performed by the audio sample rate controller 206), further description of AudioFlinger module 202, StreamOut module 204, FM player 208 and AFE 106 may be omitted here for brevity. For better understanding of technical features of the present invention, several examples of the proposed audio sample rate control method are given as below.

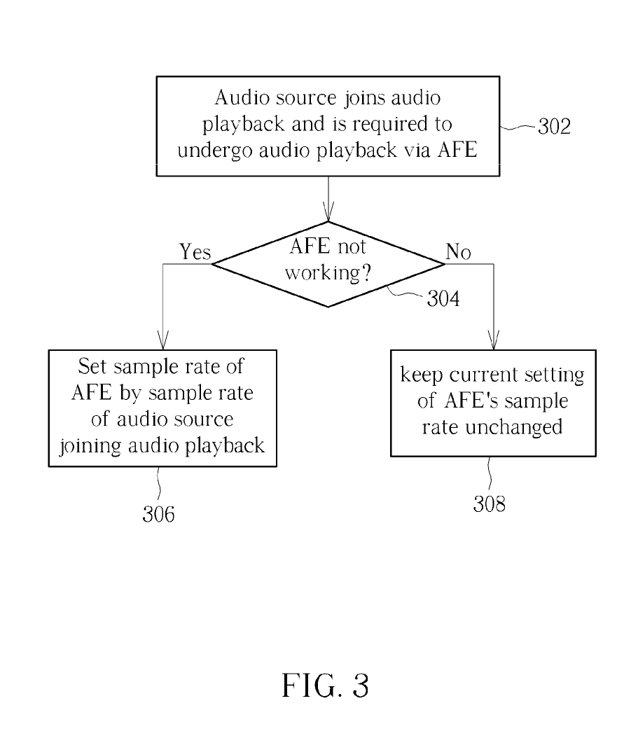

FIG. 3 is a flowchart illustrating a first decision flow of an audio sample rate control method according to an embodiment of the present invention. It should be noted that the steps are not required to be executed in the exact order shown in FIG. 3, and one or more steps can be added to or removed from the flow shown in FIG. 3. The audio sample rate control method may be performed by the audio sample rate controller 206 (which may be implemented using the program code PROG), and may be briefly summarized as below.

Step 302: An audio source may join audio playback and may be required to undergo audio playback via an audio front-end (AFE).

Step 304: Check a sample rate control criterion by referring to an operating status of the AFE. For example, if the AFE may not be working at this moment, a checking result of the sample rate control criterion may indicate that the sample rate control criterion is met, and the flow may proceed with step 306. However, if the AFE may be working at this moment, the checking result of the sample rate control criterion may indicate that the sample rate control criterion is not met, and the flow may proceed with step 308.

Step 306: Set a sample rate of the AFE by a sample rate of the audio source.

Step 308: keep a current setting of the sample rate of the AFE unchanged.

For example, when one of the audio sources (e.g., audio track 210, audio track 212 and FM player 208) may join audio playback and may be required to undergo audio playback via the AFE 106, a sample rate request of a sample rate of the audio source joining audio playback may be issued to the audio sample rate controller 206. Hence, the audio sample rate controller 206 may refer to the sample rate request to acknowledge that the audio source that issues the sample rate request may join audio playback and may be required to undergo audio playback via the AFE 106 (Step 302).

Next, the audio sample rate controller 206 may check an operating status of the AFE 106 to determine if the sample rate of the AFE 106 should be set by the sample rate of the audio source joining audio playback. If the AFE 106 may not be working at this moment, this may imply that the audio source joining audio playback may be the first audio source to be played during a new audio playback session (Step 304). That is, since the AFE 106 may not be working to drive the speaker device 108 for audio playback of any audio source, no audio playback session may exist now, and a new audio playback session may begin with the audio source joining audio playback. For example, the audio source joining audio playback may be one of the audio tracks 210 and 212, and the rest of the audio tracks 210 and 212 and the FM player 208 may not join the same audio playback session earlier.

Two audio sources may be regarded as belonging to the same audio playback session if the audio sources are temporarily correlated. In a first example of the same audio playback session, the audio source joining audio playback (e.g., one of the audio tracks 210 and 212 and the FM player 208) may be started during audio playback of the other of the audio sources (e.g., the other of the audio tracks 210 and 212 and the FM player 208). In a second example of the same audio playback session, the audio source joining audio playback (e.g., one of the audio tracks 210 and 212 and the FM player 208) may be started immediately after the end of audio playback of the other of the audio sources (e.g., the other of the audio tracks 210 and 212 and the FM player 208). In a third example of the same audio playback session, an interval between a start time of the audio source joining audio playback (e.g., one of the audio tracks 210 and 212 and the FM player 208) and an end time of the other of the audio sources (e.g., the other of the audio tracks 210 and 212 and the FM player 208) may be shorter than a predetermined threshold (e.g., 3 seconds).

In some embodiments, the first audio source of one audio playback session may be a main audio source. Hence, the audio sample rate controller 206 may configure the sample rate of the AFE 106 by the sample rate of the audio source (Step 306), such that no sample rate conversion may be applied to the audio source joining audio playback. Since the sample rate conversion for the main audio source of the audio playback session can be omitted, the audio playback session therefore may have lower power consumption and/or better audio quality.

If the AFE 106 may be working at this moment, this may imply that the audio source joining audio playback may not be the first audio source to be played during a current audio playback session (Step 304). For example, the audio source joining audio playback may be one of the audio tracks 210 and 212 and the FM player 208; however, the other of the audio tracks 210 and 212 and the FM player 208 may join the same audio playback session earlier. In other words, the audio source joining audio playback may not be the main audio source for the current audio playback session. Hence, sample rate conversion may be allowed for the audio source joining audio playback. In this example, the audio sample rate controller 206 may keep the current setting of the sample rate of the AFE 106 unchanged (Step 308), where the current setting of the sample rate of the AFE 106 may be made in response to the sample rate of the main audio source of the current audio playback session (e.g., the sample rate of the first audio source of the current audio playback session). If the sample rate of the audio source joining audio playback may be different from the current setting of the sample rate of the AFE 106, sample rate conversion operation may be applied to the audio source joining audio playback. If the sample rate of the audio source joining audio playback may be equal to the current setting of the sample rate of the AFE 106, no sample rate conversion operation may be applied to the audio source joining audio playback.

As mentioned above, the audio sample rate controller 206 may indirectly apply sample rate control to the AFE 106 via AudioFlinger module 202 and StreamOut module 204. For example, the audio sample rate controller 206 may refer to the sample rate of the audio track joining audio playback to configure an audio parameter of the AudioFlinger module 202 for sample rate change. The AudioFlinger module 202 may configure the StreamOut module 204 correspondingly. Then the StreamOut module 204 may configure the sample rate setting of an audio driver of the AFE 106 to thereby set the sample rate of the AFE 106. The sample rate conversion may not be performed by the AudioFlinger module 202 if the sample rate of the audio track joining audio playback may be equal to the current setting of the sample rate of the AFE 106.

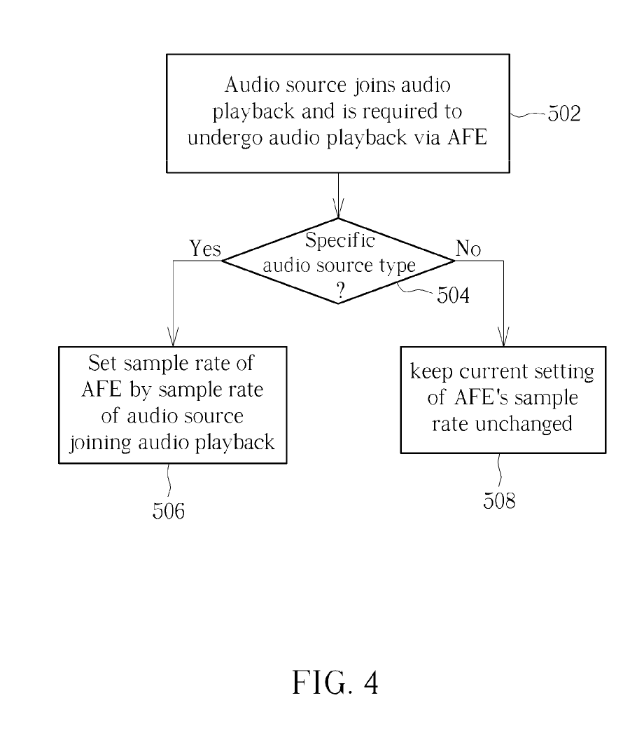

FIG. 4 is a flowchart illustrating a second decision flow of an audio sample rate control method according to an embodiment of the present invention. It should be noted that the steps are not required to be executed in the exact order shown in FIG. 4, and one or more steps can be added to or removed from the flow shown in FIG. 4. The audio sample rate control method may be performed by the audio sample rate controller 206 (which may be implemented using the program code PROG), and may be briefly summarized as below.

Step 502: An audio source may join audio playback and may be required to undergo audio playback via an audio front-end (AFE).

Step 504: Check a sample rate control criterion by referring to an audio source type of the audio source. For example, if the audio source may be an audio source with a specific audio source type, a checking result of the sample rate control criterion may indicate that the sample rate control criterion is met, and the flow may proceed with step 506. If the audio source may not be the audio source with the specific audio source type, the checking result of the sample rate control criterion may indicate that the sample rate control criterion is not met, and the flow may proceed with step 508. By way of example, but not limitation, the specific audio source type may correspond to a predetermined audio source, a predetermined frequency, and/or a predetermined sample rate.

Step 506: Set a sample rate of the AFE by a sample rate of the audio source.

Step 508: keep a current setting of the sample rate of the AFE unchanged.

For example, when one of the audio sources (e.g., audio track 210, audio track 212 and FM player 208) may join audio playback and may be required to undergo audio playback via the AFE 106, a sample rate request of a sample rate of the audio source joining audio playback may be issued to the audio sample rate controller 206. Hence, the audio sample rate controller 206 may refer to the sample rate request to acknowledge that the audio source that issues the sample rate request may be required to undergo audio playback via the AFE 106 (Step 502).

Next, the audio sample rate controller 206 may check if the audio source joining audio playback has a specific audio source type to determine whether to set the sample rate of the AFE 106 by the sample rate of the audio source joining audio playback. In one exemplary design, one audio source with the specific audio source type may be a radio broadcasting input. Hence, when the audio source joining audio playback may be the FM player 208, the audio sample rate controller 206 may decide that the sample rate of the AFE 106 should be set by the sample rate of the FM player output (Steps 504 and 506). For example, if the audio source joining audio playback may be the FM player 208 and may not be the first audio source of a current audio playback session, the current setting of the sample rate of the AFE 106 may be overridden by the sample rate of the FM player output.

However, when the audio source joining audio playback may be one of the audio tracks 210, 212 rather than the FM player 208, the audio sample rate controller 206 may keep the current setting of the sample rate of the AFE 106 unchanged (Steps 504 and 508). For example, if the audio source joining audio playback may not be the FM player 208 and may not be the first audio source of a current audio playback session, the current setting of the sample rate of the AFE 106 may be maintained to ensure the audio quality of the first audio source of the current audio playback session. If the sample rate of the audio source joining audio playback may be different from the current setting of the sample rate of the AFE 106, sample rate conversion operation may be applied to the audio source joining audio playback. If the sample rate of the audio source joining audio playback may be equal to the current setting of the sample rate of the AFE 106, no sample rate conversion operation will be applied to the audio source joining audio playback.

In another exemplary design, one audio source with the specific audio source type may be an audio input having a designated sample rate (e.g., 192 KHz or higher). Hence, when the audio source joining audio playback may be an audio input having the designated sample rate (e.g., 192 KHz or higher), the audio sample rate controller 206 may decide that the sample rate of the AFE 106 should be set by the designated sample rate (Steps 504 and 506). For example, if the audio source joining audio playback may be an audio input having the designated sample rate and may not be the first audio source of a current audio playback session, the current setting of the sample rate of the AFE 106 may be overridden by the designated sample rate. However, when the audio source joining audio playback may not be an audio input having the designated sample rate (e.g., 192 KHz or higher), the audio sample rate controller 206 may keep the current setting of the sample rate of the AFE 106 unchanged (Steps 504 and 508). For example, if the audio source joining audio playback may not be an audio input having the designated sample rate and may not be the first audio source of a current audio playback session, the current setting of the sample rate of the AFE 106 may be maintained to ensure the audio quality of the first audio source of the current audio playback session.

To put it simply, the audio source with the specific audio source type may be regarded as an audio source with higher playback priority for certain application(s). Since the sample rate of the AFE 106 may be set by the sample rate of the audio source joining audio playback (e.g., the audio source with the specific audio source type), no sample rate conversion may be applied to the audio source joining audio playback, thus ensuring the audio quality.

As mentioned above, the audio sample rate controller 206 may indirectly apply sample rate control to the AFE 106 via AudioFlinger module 202 and StreamOut module 204. For example, the audio sample rate controller 206 may refer to the sample rate of the audio track joining audio playback to configure an audio parameter of the AudioFlinger module 202 for sample rate change. The AudioFlinger module 202 may configure the StreamOut module 204 correspondingly. Then the StreamOut module 204 may configure the sample rate setting of an audio driver of the AFE 106 to thereby set the sample rate of the AFE 106. The sample rate conversion may not be performed by the AudioFlinger module 202 if the sample rate of the audio track joining audio playback may be equal to the current setting of the sample rate of the AFE 106.

In accordance with the example shown in FIG. 3, the audio sample rate controller 206 may make decision on whether to set the sample rate of the AFE 106 according to an operating status checking result of the AFE 106. In accordance with the example shown in FIG. 4, the audio sample rate controller 206 may make decision on whether to set the sample rate of the AFE 106 according to an audio source type checking result of the audio source joining audio playback. However, these are for illustrative purposes only, and are not meant to be limitations of the present invention. Alternatively, the audio sample rate controller 206 may make decision on whether to set the sample rate of the AFE 106 according to both of an audio source type checking result of the audio source joining audio playback and an operating status checking result of the AFE 106.

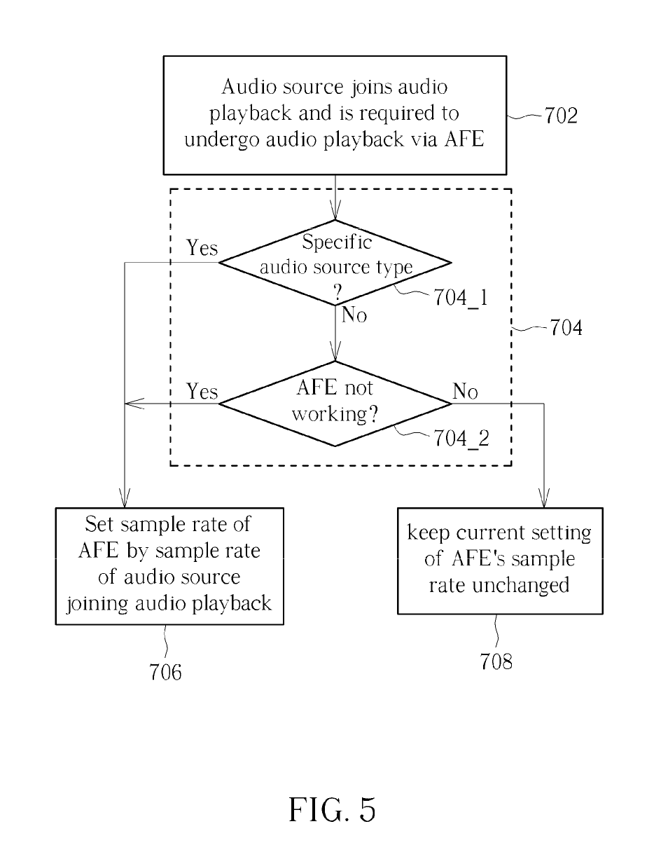

FIG. 5 is a flowchart illustrating a third decision flow of an audio sample rate control method according to an embodiment of the present invention. It should be noted that the steps are not required to be executed in the exact order shown in FIG. 5, and one or more steps can be added to or removed from the flow shown in FIG. 5. The audio sample rate control method may be performed by the audio sample rate controller 206 (which may be implemented using the program code PROG), and may be briefly summarized as below.

Step 702: An audio source may join audio playback and may be required to undergo audio playback via an audio front-end (AFE).

Step 704: Check a sample rate control criterion to determine whether to set the sample rate of the AFE. When a checking result of the sample rate control criterion may indicate that the sample rate control criterion is met, the flow may proceed with Step 706. When the checking result of the sample rate control criterion may indicate that the sample rate control criterion is not met, the flow may proceed with step 708.

Step 706: Set a sample rate of the AFE by a sample rate of the audio source.

Step 708: keep a current setting of the sample rate of the AFE unchanged.

In this example, step 704 may include two sub-steps 704_1 and 704_2. In sub-step 704_1, the audio sample rate controller 206 may refer to an audio source type of the audio source joining audio playback to determine if the audio source joining audio playback may be an audio source with a specific audio source type. When the audio source joining audio playback may be the audio source with the specific audio source type, the checking result of the sample rate control criterion may indicate that the sample rate control criterion is met, and the flow may proceed with step 706. When the audio source may not be the audio source with the specific audio source type, the flow may proceed with the sub-step 704_2. In sub-step 704_2, the audio sample rate controller 206 may refer to an operating status of the AFE 106 to determine whether or not the AFE 106 may be working now. When the AFE 106 may not be working at this moment, the checking result of the sample rate control criterion may indicate that the sample rate control criterion is met, and the flow may proceed with step 706. When the AFE may be working at this moment, the checking result of the sample rate control criterion may indicate that the sample rate control criterion is not met, and the flow may proceed with step 708.

As a person skilled in the art can readily understand details of each step shown in FIG. 5 after reading above paragraphs related to the examples shown in FIG. 3 and FIG. 4, further description is omitted here for brevity.

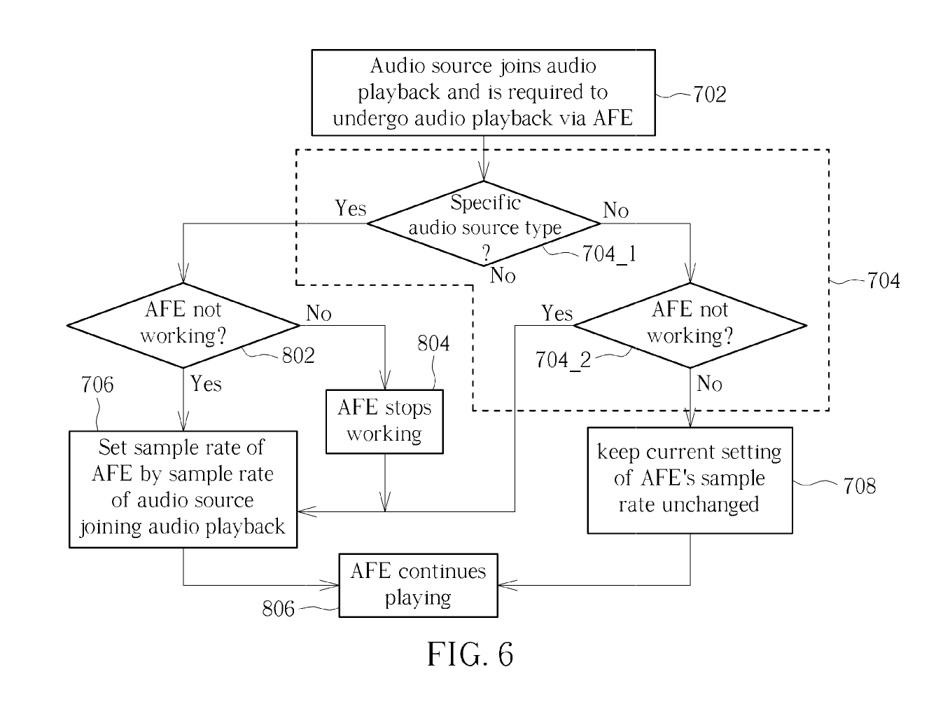

FIG. 6 is a flowchart illustrating a fourth decision flow of an audio sample rate control method according to an embodiment of the present invention. It should be noted that the steps are not required to be executed in the exact order shown in FIG. 6, and one or more steps can be added to or removed from the flow shown in FIG. 6. The audio sample rate control method may be performed by the audio sample rate controller 206 (which may be implemented using the program code PROG). The fourth decision flow of audio sample rate control shown in FIG. 6 may be derived from adding additional steps to the aforementioned third decision flow of audio sample rate control shown in FIG. 5. Concerning the embodiment shown in FIG. 5, the flow may directly proceed with step 706 after the sample rate control criterion is met due to the audio source joining audio playback being an audio source with a specific audio source type. In this embodiment shown in FIG. 6, the flow may goes to step 706 via one or more intermediate steps (e.g., step 802 and/or step 804) after the sample rate control criterion is met due to the audio source joining audio playback being an audio source with a specific audio source type. For example, in sub-step 704_1, the audio sample rate controller 206 may refer to an audio source type of the audio source joining audio playback to determine if the audio source joining audio playback may be an audio source with a specific audio source type. When the audio source joining audio playback may be the audio source with the specific audio source type, the checking result of the sample rate control criterion may indicate that the sample rate control criterion is met, and the flow may proceed with step 802.

In step 802, the audio sample rate controller 206 may refer to an operating status of the AFE 106 to determine whether or not the AFE 106 may be working now. If the AFE 106 may not be working at this moment, the flow may proceed with step 706 to configure the sample rate of the AFE 106. If the AFE 106 may be working at this moment, the flow may proceed with step 804 to stop the AFE 106 from working. For example, the StreamOut module 204 may inform the AudioFlinger module 202 of an invalid operation, and then the AudioFlinger module 202 may stop the current audio playback of the AFE 106. Next, the flow may proceed with step 706 to configure the sample rate of the AFE 106. Hence, the AFE 106 may operate under a sample rate equal to the sample rate of the audio track joining audio playback (steps 706 and 806), or may operate under an unchanged current sample rate setting (steps 708 and 806).

As a person skilled in the art can readily understand details of other steps shown in FIG. 6 after reading above paragraphs related to the examples shown in FIGS. 3-5, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. An audio sample rate control method comprising:
when an audio source is required to undergo audio playback via an audio front-end (AFE), checking a sample rate control criterion; and
performing sample rate control upon the AFE according to a checking result of the sample rate control criterion.

2. The audio sample rate control method of claim 1, wherein checking the sample rate control criterion comprises:
obtaining the checking result according to an operating status of the AFE.

3. The audio sample rate control method of claim 2, wherein performing the sample rate control upon the AFE comprises:
when the AFE is not working, setting a sample rate of the AFE by a sample rate of the audio source.

4. The audio sample rate control method of claim 2, wherein performing the sample rate control upon the AFE comprises:
when the AFE is working, keeping a current setting of a sample rate of the AFE unchanged.

5. The audio sample rate control method of claim 1, wherein checking the sample rate control criterion comprises:
obtaining the checking result according to an audio source type of the audio source.

6. The audio sample rate control method of claim 5, wherein performing the sample rate control upon the AFE comprises:
when the audio source is an audio source with a specific audio source type, setting a sample rate of the AFE by a sample rate of the audio source.

7. The audio sample rate control method of claim 6, wherein the audio source with the specific audio source type is a radio broadcasting input or an audio input having a designated sample rate.

8. The audio sample rate control method of claim 5, wherein performing the sample rate control upon the AFE comprises:
when the audio source is not an audio source with a specific audio source type, keeping a current setting of a sample rate of the AFE unchanged.

9. The audio sample rate control method of claim 8, wherein the audio source with the specific audio source type is a radio broadcasting input or an audio input having a designated sample rate.

10. The audio sample rate control method of claim 1, wherein checking the sample rate control criterion comprises:
obtaining the checking result according to an audio source type of the audio source and an operating status of the AFE.

11. The audio sample rate control method of claim 10, wherein performing the sample rate control upon the AFE comprises:
when the audio source is not an audio source with a specific audio source type and the AFE is not working, setting a sample rate of the AFE by a sample rate of the audio source.

12. The audio sample rate control method of claim 10, wherein performing the sample rate control upon the AFE comprises:
when the audio source is not an audio source with a specific audio source type and the AFE is working, keeping a current setting of a sample rate of the AFE unchanged.

13. A non-transitory machine readable medium having a program code stored therein, wherein when executed by a processor, the program code instructs the processor to perform following steps:
when an audio source is required to undergo audio playback via an audio front-end (AFE), checking a sample rate control criterion; and
performing sample rate control upon the AFE according to a checking result of the sample rate control criterion.

14. The non-transitory machine readable medium of claim 13, wherein checking the sample rate control criterion comprises obtaining the checking result according to an operating status of the AFE;
and performing the sample rate control upon the AFE comprises: when the AFE is not working, setting a sample rate of the AFE by a sample rate of the audio source.

15. The non-transitory machine readable medium of claim 13, wherein checking the sample rate control criterion comprises obtaining the checking result according to an operating status of the AFE;
and performing the sample rate control upon the AFE comprises: when the AFE is working, keeping a current setting of a sample rate of the AFE unchanged.

16. The non-transitory machine readable medium of claim 13, wherein checking the sample rate control criterion comprises obtaining the checking result according to an audio source type of the audio source; and performing the sample rate control upon the AFE comprises: when the audio source is an audio source with a specific audio source type, setting a sample rate of the AFE by a sample rate of the audio source.

17. The non-transitory machine readable medium of claim 16, wherein the audio source with the specific audio source type is a radio broadcasting input or an audio input having a designated sample rate.

18. The non-transitory machine readable medium of claim 13, wherein checking the sample rate control criterion comprises obtaining the checking result according to an audio source type of the audio source; and performing the sample rate control upon the AFE comprises: when the audio source is not an audio source with a specific audio source type, keeping a current setting of a sample rate of the AFE unchanged.

19. The non-transitory machine readable medium of claim 13, wherein checking the sample rate control criterion comprises obtaining the checking result according to an audio source type of the audio source and an operating status of the AFE; and performing the sample rate control upon the AFE comprises: when the audio source is not an audio source with a specific audio source type and the AFE is not working, setting a sample rate of the AFE by a sample rate of the audio source.

20. The non-transitory machine readable medium of claim 13, wherein checking the sample rate control criterion comprises obtaining the checking result according to an audio source type of the audio source and an operating status of the AFE; and performing the sample rate control upon the AFE comprises: when the audio source is not an audio source with a specific audio source type and the AFE is working, keeping a current setting of a sample rate of the AFE unchanged.
